(19) United States
(12) Patent Application Publication
(10) Pub. No.: US 2020/0026840 A1
(43) Pub. Date: Jan. 23, 2020

(54) AUTHENTICATION PROCEDURES WITH RANDOMIZATION OF PRIVATE INPUT INTERFACE

(71) Applicant: CA, Inc., New York, NY (US)

(72) Inventors: Rohit Pathak, Bangalore (IN); Abhijeet Kumar Singh, Muzaffarpur (IN); Sanjaya Kumar Sahu, Bangalore (IN); Alok Gupta, Bangalore (IN)

(21) Appl. No.: 16/039,035

(22) Filed: Jul. 18, 2018

(51) Int. Cl. G06F 21/35; H04L 29/06; H04L 12/24; H04W 12/06

(52) U.S. Cl. CPC G06F 21/35; H04W 12/06; H04L 41/08; H04L 63/083

(57) ABSTRACT

Techniques are disclosed relating to using a randomized private input interface to secure passcode information. In some embodiments, a mobile device receives configuration information for user input of a passcode to another device. In some embodiments, the configuration information specifies a pseudo-random relationship of input values to input actions recognized by the other device. In some embodiments, a private interface is displayed based on the configuration information, where the private interface is visible to a user of the mobile device and not to others. In various embodiments, the disclosed techniques may reduce the ability of other nearby individuals to determine information entered by the user.

### BACKGROUND

### Technical Field

This disclosure relates generally to user authentication techniques and more particularly to using a randomized private input interface to secure passcode information.

### Description of the Related Art

User authentication for various activities often involves receiving user input of personally identifiable information (PII) such as a passcode. For example, users performing transactions may input a passcode via a keypad after otherwise identifying themselves (e.g., using a card or wireless device associated with a transaction account). Even with privacy measures such as screens or booths for such input, others standing nearby may watch or record user input of the passcode, which may reduce transaction security.

### SUMMARY

Techniques are disclosed relating to the security of user information during an authentication procedure. In some embodiments, for an authentication transaction, the authentication device generates one or more pseudo-random input value configurations and wirelessly transmits the one or more configurations to the mobile device associated with the user. In some embodiments, the mobile device generates emissions that cause a private interface to appear to the user based on the one or more pseudo-random configurations. In some embodiments, the private interface is not visible to other users (e.g., it may be generated by a wearable augmented reality, mixed reality, or virtual reality mobile device of the user). In some embodiments, the authentication device verifies a passcode that is input based on the private interface. In some embodiments, disclosed techniques may reduce or prevent situations where others determine the passcode without authorization.

### BRIEF DESCRIPTION OF THE DRAWINGS

FIG. 1 is a block diagram illustrating an exemplary authentication system that displays a randomized private interface for passcode entry, according to some embodiments.

FIGS. 2A-2C are block diagrams illustrating exemplary relationships between input values and user input locations, according to some embodiments.

FIG. 3 is a block diagram illustrating an exemplary authentication system configured to receive gesture-based user input, according to some embodiments.

FIG. 4 is a block diagram illustrating an exemplary authentication system configured to interact with a passive headset, according to some embodiments.

FIG. 5 is a flow diagram illustrating an exemplary method for displaying a pseudo-randomly generated input value configuration, using a private interface, during an authentication procedure, according to some embodiments.

FIG. 6 is a flow diagram illustrating an exemplary method for performing an authentication procedure based on user input using a pseudo-randomly generated input value configuration, according to some embodiments.

FIG. 7 is a block diagram illustrating an exemplary computing device, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. An “authentication device configured to pseudo-randomly generate relationships between input actions and input values” is intended to cover, for example, a device that performs this function during operation, even if the corresponding device is not currently being used (e.g., when its battery is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed mobile computing device, for example, would not be considered to be “configured to” perform some specific function, although it may be “configurable to” perform that function. After appropriate programming, the mobile computing device may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the term “processing element” refers to various elements configured to execute program instructions (or portions thereof or combinations thereof). Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof.

### DETAILED DESCRIPTION

### Exemplary Authentication System

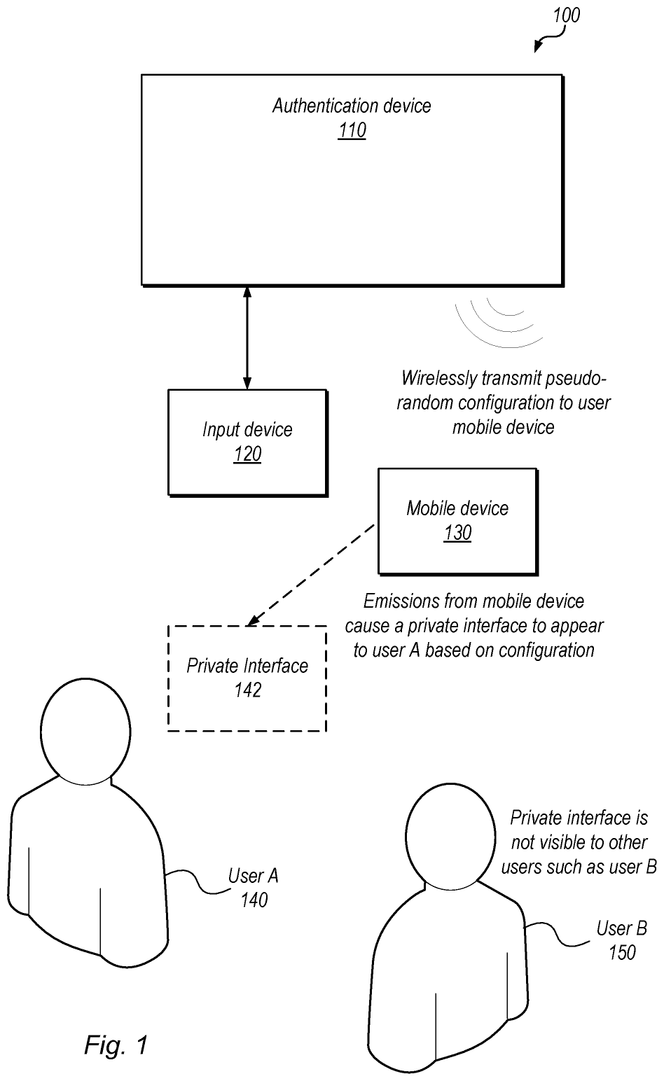

This disclosure is generally directed to techniques for receiving authentication input based on a private interface that displays a pseudo-random configuration of relationships between input actions and input values. FIG. 1 is a block diagram illustrating an exemplary authentication system that displays a randomized private interface for passcode entry, according to some embodiments. In the illustrated embodiment, authentication system 100 includes: authentication device 110, mobile device 130, and input device 120. In the illustrated embodiment, mobile device 130 generates private interface 142, which is visible to user A 140 but not visible to user B 150. In some embodiments, the authentication system 100 is configured to produce an authentication result for a procedure initiated by a user. For example, an authentication procedure may be performed for one or more of the following: ATM transactions, access authorization (e.g., physical access to a secure location, access to one or more devices, access to information, etc.), online transactions, etc. Authentication system 100, in the illustrated embodiment, provides an example embodiment of wireless communication between a mobile device and an authentication device to coordinate secure entry of information during an authentication procedure.

Authentication device 110, in the illustrated embodiment, wirelessly transmits one or more pseudo-random configurations of input values to a mobile device 130 associated with user A 140.

Mobile device 130, in the illustrated embodiment, causes a private interface 142 to appear to user A 140 based on the one or more pseudo-random input value configurations.

Input device 120, in the illustrated embodiment, receives input of a passcode (e.g., from user A based on the private interface 142) and the authentication device 110 verifies the passcode based on the pseudo-random configuration.

Input device 120 may be a touchpad used to enter a personal identification number (PIN), for example. In this situation, the pseudo-random configuration may specify relationships between input values (e.g., numbers) and locations on the touchpad. The private interface 142 may overlay the input values on the locations such that user A 140 can input a passcode based on the private interface without exposing the passcode to user B.

In some embodiments, authentication device 110 communicates with mobile device 130 wirelessly using a standard such as BLUETOOTH®, wireless local area network (WLAN) (e.g., Wi-Fi), Wi-Fi direct, etc. In other embodiments, the configuration information is sent through a wired connection between authentication device 110 and mobile device 130. In some embodiments, authentication device 110 transmits configuration information to only one mobile device at a time, e.g., using a secure channel established with the mobile device.

In some embodiments, the authentication device 110 transmits configuration information based on user A 140 initiating an authentication procedure. In some embodiments, the authentication device transmits new configuration information for one or more new authentication procedures (e.g., a second authentication procedure for user A 140 or a first authentication procedure for another user). In some embodiments, user A initiates an authentication procedure by one or more of the following: swiping or inserting a card, positioning a short-range communication device at or near a certain location, entering a username/password, inputting biometric information, putting on a wearable device associated with the authentication device, etc.

In some embodiments, the one or more pseudo-random input value configurations, transmitted to the mobile device 130, are generated by authentication device 110. In some embodiments, one or more random number generators (RNG) or randomizing elements included in authentication device 110 are used to generate these randomized relationships between input actions and input values. Pseudo-random generation of relationships between input values and input actions may be performed using any of various appropriate implementations, including one or more random number generators. The term “pseudo-random” refers to values that satisfy one or more statistical tests for randomness but are typically produced using a definite mathematical process, e.g., based on one or more seed values. In some embodiments, any of various sequences described herein as pseudo-random may actually be random, but true randomness is typically difficult to achieve using computer hardware. In some embodiments, among a set of N input values each having an index, a particular input value may be selected from the set for association with a particular input action using a determined random number modulus N, for example. In some embodiments, the selected input value is removed from the set of N input values once it has been associated with a particular input action.

Mobile device 130, in some embodiments, is a headset (e.g., a virtual reality, augmented reality headset, or mixed reality). In these embodiments, mobile device 130 may generate emissions using one or more displays positioned in front of one or both eyes of the user. In other embodiments, mobile device 130 may be one or more of the following: another type of wearable device, a mobile phone, a projector, etc.

In some embodiments, mobile device 130 may be a common device used by multiple different individuals accessing authentication device 110. For example, mobile device 130 may remain at the location of authentication device 110 (and may even be tethered to location 110). Although mobile device 130 is discussed herein for purposes of illustration, non-mobile devices may perform similar functionality in other embodiments. In some embodiments, mobile device 130 may be a personal device of user A. In embodiments where mobile device 130 is a personal device of user A 140, authentication device 110 may use various different techniques to identify mobile device 130. For example, in some embodiments, authentication device 110 may use signal strength and/or registration information of one or more devices to determine which mobile device to transmit configuration information to.

Authentication device 110, in some embodiments, is configured to determine signal strength of one or more devices that support wireless communications supported by device 110. In some embodiments, authentication device 110 selects a device with the largest detected signal strength with which to communicate for authentication. Speaking generally, a device with a greater signal strength may be closer to authentication device 110 than a device with a lower signal strength. In embodiments in which other criteria are used to determine which device to communicate with (e.g., registration as discussed below), authentication device 110 may still communicate with only devices that meet a signal strength threshold for authentication.

In some embodiments, mobile device 130 is registered with a particular account and/or user. For example, the user A 140 may register their mobile device 130 with one or more relevant accounts prior to performing authentication transactions for those accounts. The mobile device 130 may receive a shared secret during registration, which may allow the authentication device 110 and the registered mobile device to perform mutual authentication during an authentication procedure. Authentication device 110 may send configuration information to mobile device 130 only after authenticating the device, in these embodiments (note that authentication of the registered device may not actually authenticate the user, and the user may be authenticated subsequently based on their passcode).

Note that, in some embodiments, transmitting pseudo-random configuration information to an unauthorized device may not be a security concern, so long as the authentication device 110 transmits the information to only one device. For example, if authentication device 110 sends pseudo-random configuration information to a device of user B, user A will not have a reference and will not attempt to enter a passcode. Therefore, even though user B would have knowledge of the relationship between input actions and input values, in this example, user B will have no knowledge of the input values of the correct password. Therefore, in embodiments that use signal strength alone, for example, sending configuration information to an unintended user may not be problematic.

In some embodiments, the configuration information transmitted to mobile device 130 from device 110 is encrypted. Various encryption techniques may be used by authentication device 110 to encrypt pseudo-random configuration information for an authentication procedure, including the following: Triple Data Encryption Standard (3DES), Advanced Encryption Standard (AES), Private/Public key, etc.

In some embodiments, authentication device 110 sends instructions to input device 120 specifying one or more public configurations that are different than the configuration of private interface 142 to display on the input device (e.g., display to the general public, or to other users such as user B 150).

In some embodiments, input actions may include verbal inputs. For example, input device 120 may include a microphone that receives one or more verbal inputs from the user A 140. Consider, for example, a private interface 142 that displays the numbers 1, 2, and 3 in the colors red, blue, and green, respectively. In this example, the user may say the words “red,” “blue,” and “green” to respectively signal input values “1,” “2,” and “3.” In this case, the pseudo-random relationship is between input actions of verbally speaking colors and numeric input values.

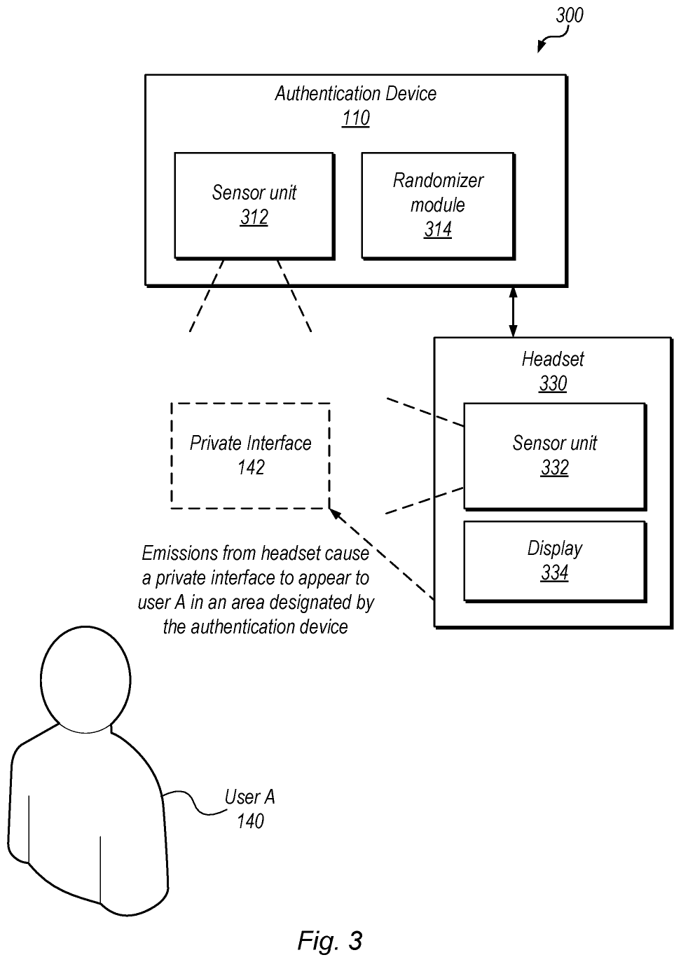

As discussed below in detail with reference to FIG. 3, input actions may include gestures. Note that although various types of input actions are discussed herein for purposes of explanation (e.g., selecting touchscreen inputs, verbal commands, gestures, etc.), these examples are not intended to limit the scope of the present disclosure. In various embodiments, input device 120 may be configured to receive any of various appropriate types of input actions from the user that are pseudo-randomly related to input values.

As used herein, the term “passcode” is intended to be construed broadly according to its well-understood meaning, which includes information that includes various symbols including numbers, upper and/or lowercase letters, special characters, other symbols, images, etc. Examples of passcodes include personal identification numbers (PINs) and passwords. Although various embodiments discussed herein improve passcode security, similar techniques may be used for any of various non-passcode private information to be input by a user. Passcodes are discussed for purposes of illustration but are not intended to limit the scope of the present disclosure.

### Example Input Value Configurations

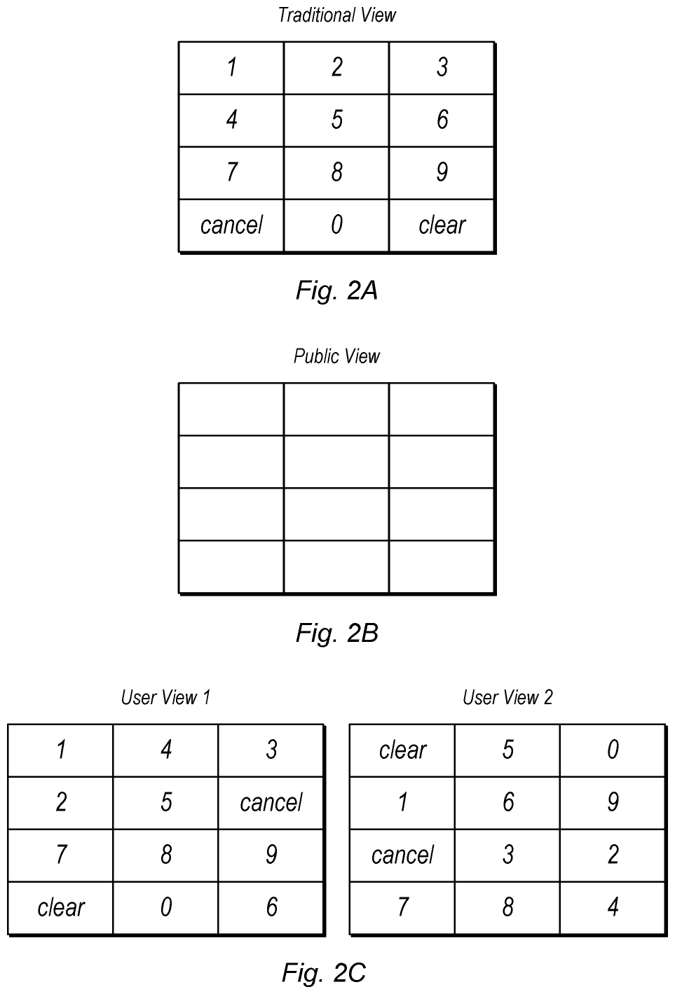

FIGS. 2A-2C are block diagrams illustrating exemplary relationships between input values and user input locations, according to some embodiments. FIG. 2A displays a traditional view of a keypad. User selection of a location on the keypad (which may be mechanical or a touchscreen, for example) indicates a selection of the corresponding input value.

In various disclosed embodiments, a keypad may appear differently to other users than to a user associated with mobile device 130. In the illustrated example, FIG. 2B shows a blank keypad visible to the public while FIG. 2C shows two example user views that may be visible on the private interface generated by mobile device 130 during an authentication procedure.

The input value configurations displayed in FIG. 2A-2C, may be displayed on a keypad, keyboard, touchscreen, solid-colored backdrop, etc., depending on the type of input device 120 being used during an authentication procedure. Additionally, the configurations may be displayed within coordinates of a space defined by the authentication device 110 (and may not appear to be associated with any physical location of a device), in embodiments with gesture input. As discussed above with reference to FIG. 1, the input values of the private interface may be overlaid/projected onto an input area of an input device (e.g., a keyboard), rather than being displayed by the device itself (e.g., displayed on a touchscreen).

Note that selectable input locations may be any of various appropriate shapes (e.g., may be circles, squares, stars, etc.) in addition to or in place of the rectangular shapes shown in the illustrated embodiment.

FIG. 2A, in the illustrated embodiment, shows a traditional view of a keypad/keyboard with numbers displayed in ascending order from left to right. In the illustrated embodiment, the user interface displayed in FIG. 2A also includes the input values “cancel” and “clear”. In some embodiments, the locations associated with the input values “cancel” and “clear” allow the user to cancel an authentication procedure or clear an erroneous passcode entry.

In some embodiments, the traditional view (shown in FIG. 2A) is visible to the public, while a different configuration (e.g., one of the configurations of FIG. 2C) is displayed to user A 140 on a private interface during an authentication procedure. In other embodiments, the view visible to the public includes blank locations, e.g., as shown in FIG. 2B. In some embodiments, displaying different symbols on the private interface than the symbols that are publicly visible reduces the ability of others in the area of the user to determine the combination of inputs entered by the user (e.g., a passcode sequence).

FIG. 2C, in the illustrated embodiment, shows user views 1 and 2 with scrambled (e.g., pseudo-random) numbers and words with respect to the traditional view displayed in FIG. 2A. In the illustrated embodiment, user view 1 shows that four input values are displayed in different locations than the locations in the traditional view of FIG. 2A. In contrast, in the illustrated embodiment, user view 2 shows that all input values are displayed in different locations than the locations shown in FIG. 2A. In some embodiments, the pseudo-random configurations shown in FIG. 2C contain the information displayed only to the user A 140 via the private interface. As discussed above with reference to FIG. 1, one or more random number generators and/or other randomizing algorithms/elements may be used to generate pseudo-random input value configurations, such as those shown in FIG. 2C.

In some embodiments, a single pseudo-random user view is generated for entry of all input values of a given passcode. In other embodiments, multiple user views may be generated for entry of different values of the same passcode. For example, a user may be prompted to enter a first input value of a multi-value passcode using user view 1, a second input value of a multi-value passcode using user view two, and subsequent input values using additional pseudo-randomly generated private interfaces (not shown).

In some embodiments, the private interface may indicate time-based relationships between input actions and input values. As one example for numerical input values, the interface may count up from zero to nine before beginning again. In this example, the user may take an action (e.g., perform a gesture or press a button) when their desired input value is displayed.

In some embodiments, the input values may include images or portions of an image. For example, the private interface 142 shown in FIG. 1 may display pseudo-randomly ordered images of different animals and the user may select a particular sequence of animals. As another example, a user may select particular portions of one or more images in a particular sequence to input a passcode.

In some embodiments, an input action may be related to input of an entire passcode or multiple symbols of a passcode. For example, the private interface 142 may display a number of different passcodes in a pseudo-random ordering to the user, and the user may select the correct passcodes. In various embodiments, user actions may include verbal actions (e.g., speaking), physical actions (e.g., clicking, gesturing, selecting), and/or other types of actions.

### Exemplary Authentication System Involving Gesture Based User Inputs

FIG. 3 is a block diagram illustrating an exemplary authentication system configured to receive gesture-based user input, according to some embodiments. In the illustrated embodiment, authentication system 300 includes randomizer module 314, sensor unit 312, headset 330, sensor unit 332, and display 334. Note that sensor unit 312 is one example of the input device 120 of FIG. 1.

Randomizer module 314, in some embodiments, is configured to pseudo-randomly generate configuration information that specifies relationships between input values and input actions and sends this information to headset 330. As discussed above with reference to FIG. 1, in some embodiments, randomizer module 314 includes one or more random number generators and/or one or more other randomizing elements combined to generate pseudo-random configurations.

Sensor unit 312, in the illustrated embodiment, is configured to monitor one or more gestures in a monitored region. Note that the region may have one, two, or more dimensions, in various embodiments. In some embodiments, sensor unit 312 monitors verbal inputs, as well as other input actions from user A 140. In some embodiments, gestures from the user may include one or more movements by the user's: eyes, hands, mouth, fingers, smile, eyebrows, etc. In some embodiments, the one or more gestures from the user are associated with signaling one or more inputs (e.g., input actions) from the user based on the configuration information.

In some embodiments, the monitored region is defined by coordinates based on a desired location for input by the user. In some embodiments, the designated region is specified using one or more of the following: an image, geographical coordinates, one or more beacons, a greenscreen, etc. In some embodiments, authentication device 110 sends information about the designated region to headset 330. Headset 330 may then determine the region (e.g., by determining its position relative to the coordinates, searching for a specified image, beacon, or greenscreen, etc., and causing display of the private interface in the determined position). In some embodiments, information about the region is stored on the mobile device prior to an authentication procedure, e.g., during registration. In other embodiments, the authentication device 110 may not designate a region for recognizing gestures but may scan for gestures within its visible range.

Headset 330, in the illustrated embodiment, is one example embodiment of mobile device 130. In the illustrated embodiment, headset 330 receives configuration information, generated by randomizer module 314, from authentication device 110. In some embodiments, headset 330 communicates wirelessly with authentication device 110 to receive configuration information. In the illustrated embodiment, emissions from headset 330 cause one or more pseudo-random input value configurations to appear to user A 140 within private interface 142. In some embodiments, the emissions are generated by display 334, which may be located in front of the user's eyes. In some embodiments, the emissions cause the private interface 142 to be displayed within the monitored region.

In embodiments discussed above, authentication device 110 monitors for gesture-based inputs. In other embodiments, the mobile device (e.g., headset 330) may monitor for gesture-based input in addition to or in place of authentication device 110. For example, sensor unit 332, in the illustrated embodiment, monitors gestures from user A 140 during an authentication procedure. In some embodiments, headset 330 sends input information to the authentication device 110 based on information gathered at sensor unit 332. In some embodiments, sensor units 312 and 332 include one or more sensor elements that coordinate to generate information about movement from user A 140. In various embodiments, sensor units 312 and 332 monitor one or more different types of input actions from the user. For example, units 312 and 332 may monitor both gesture-based communication and verbal communication, along with other various types of communication from the user. In some embodiments, sensor units 312 and 332 monitor movement from the user with one or more of the following types of sensors: sonar, audio (e.g., a microphone), ultrasonic, infrared radiation (IR), passive infrared (PIR), etc.

In some embodiments, headset 330 includes one or more screens (e.g., display 334 includes a separate screen for each eye of the user) to display information to user A 140. In some embodiments, headset 330 includes one or more shield elements to reduce outside illumination and/or prevent others (e.g., user B 150) from viewing the information displayed to user A. As discussed above with reference to FIG. 1, in some embodiments, headset 330 is a virtual reality (VR), augmented reality (AR), or mixed reality (MR) device.

In some embodiments, a VR headset generates a three-dimensional environment displayed to a user. In some embodiments, a virtual reality environment completely replaces the user's view of their physical environment, providing a computer-generated environment in its place. In some embodiments, an AR headset displays computer-generated elements to the user that are layered over their physical environment. Thus, in some embodiments, an AR headset enhances the user's environment by using a forward-facing camera to determine where to place elements in relation to the physical or real-world environment that the user is currently viewing. In some embodiments, a mixed reality headset may be similar to an AR headset, but may or may not include additional functionality such as anchoring virtual objects. In some embodiments, mobile device 130 is configured to alter and/or add to the auditory environment of the user in addition to the visual environment of the user.

In various embodiments, the headsets discussed above are used to show the user one or more of their gestures in an alternate state than their physical environment. In some embodiments, the headset 330 is a VR headset that shows the user a virtual reproduction or a virtual representation (e.g., a cartoon drawing of their hands, an arrow representing their hand location, etc.) of one or more gestures. In some embodiments, the headset 330 is an AR headset and the user sees their hands through a video feed generated by an outward facing camera on the AR headset. In some embodiments, an AR headset display is transparent, allowing the user to see their own hands in addition to other elements displayed by the headset to appear in the user's line of sight (e.g., an arrow overlaid on a hand of the user). Note that gestures represented by headset 330 may include both gestures that correspond to input actions and other gestures that do not correspond to input actions. For example, user movements may be represented even if they do not correspond to a recognized gesture.

One example of a virtual or augmented representation of one or more gestures from the user includes a current eye direction. For example, a user may look (e.g., one type of represented gesture) at a specific location in the area designated by authentication device 110. In this example, if the user “blinks” (e.g., an input action of the user, represented by a gesture) the eye currently looking at the specific location, an input value (e.g., a number) may be selected. Note that this example may be described as a single input action with multiple components (looking and blinking) or may be described as multiple input actions that together correspond to an input value.

As used herein, the term “module” refers to circuitry configured to perform specified operations or to physical non-transitory computer readable media that store information (e.g., program instructions) that instructs other circuitry (e.g., a processor) to perform specified operations. Modules may be implemented in multiple ways, including as a hardwired circuit or as a memory having program instructions stored therein that are executable by one or more processors to perform the operations. A hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

### Example Authentication System Configured to Generate a Private Interface

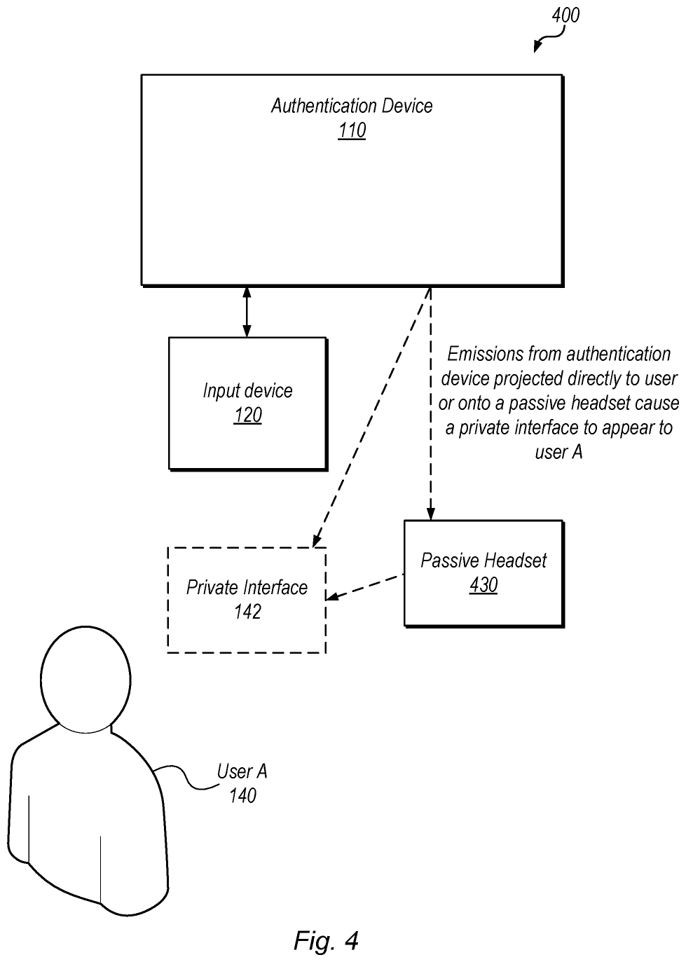

FIG. 4, is a block diagram illustrating an exemplary authentication system configured to generate a private interface, according to some embodiments. In the illustrated embodiment, authentication system 400 includes passive headset 430 and/or directly projects an interface onto the eye(s) of user A. In some embodiments, the authentication device 110 generates a pseudo-random relationship between input values and input actions and receives user input based on the relationship, without active assistance and/or communication with a headset associated with user A 140. In some embodiments, passive headset 430 does not communicate with authentication device 110 at all.

Passive headset 430, in the illustrated embodiment, receives emissions from authentication device 110 during an authentication procedure, e.g., using one or more lenses. In the illustrated embodiment, similar to embodiments described above with reference to FIGS. 1 and 3, emissions from authentication device 110 cause a private interface 142 to appear to user A 140. In some embodiments, private interface 142 appears to user A to be located at (e.g., projected onto) input device 120. In some embodiments, passive headset 430 is worn by user A 140 and initiates an authentication procedure with authentication device 110. In some embodiments, similar to headset 330, the passive headset 430 includes one or more shield elements to reduce illumination and/or prevent others from viewing the emissions projected onto headset 430. In some embodiments, passive headset 430, similar to headset 330, includes transparent lenses that allow the user to see their physical environment (e.g., the user can see their own hands when selecting input values displayed by private interface 142 at input device 120).

In some embodiments, although passive headset 430 does not actively participate in the authentication procedure, headset 430 emits some form of wireless information (e.g., beacon, NFC, Wi-Fi, etc.) that allows device 110 to identify that a device is nearby and/or determine a position of the device.

In some embodiments, device 110 emits one or more beams directly to a recognized eye of the user, e.g., when the user is not wearing a headset. For example, device 110 may direct one or more beams of light to an eye of the user recognized based on registration information concerning one or both eyes of the user, removing the need for a wearable device. Further, in this example, others in the area of the user may not be able to see the private interface 142, because it is sent directly to the eye of the user. This may advantageously protect private information of the user by prohibiting others from seeing the correct passcode entered by the user at input device 120, because others cannot comprehend the association between input values and input actions (e.g., clicking, gesturing, speaking, etc.) of the user when they input a passcode.

In some embodiments, authentication device 110 generates and projects a hologram, based on configuration information, in such a manner that the hologram is visible to the user but is not visible to other nearby users. For example, the hologram may be oriented such that private interface 142 is clearly visible from a particular angle corresponding to the user's line of sight (e.g., based on tracking the eyes of the user) but is at least partially obscured from other angles.

In some embodiments, device 110 may project one or more beams, holograms, and/or volumetric displays for private interface 142 onto one or more lenses of passive headset 430. In some embodiments, one or more beams, holograms, or volumetric displays are projected at one or more lenses or mirrors on passive headset 430 that transmits received beams to the user's eyes.

In some embodiments, e.g., using holograms, other users may view a different interface from their viewing angles than the interface shown in private interface 142, e.g., as broadly discussed above with reference to FIG. 2.

### Exemplary Methods

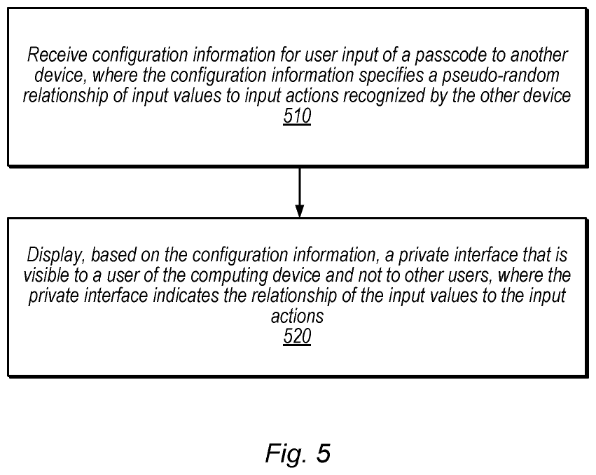

FIG. 5 is flow diagram illustrating an exemplary method for displaying a pseudo-randomly generated private interface during an authentication procedure, according to some embodiments. The method shown in FIG. 5 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 510, in the illustrated embodiment, the mobile device receives configuration information for user input of a passcode to another device, where the configuration information specifies a pseudo-random relationship of input values to input actions recognized by the other device. In some embodiments, the configuration information includes different sets of pseudo-random relationships of the input values to input actions for input of different portions, by the user, of the passcode. In some embodiments, the mobile device determines gestures of the user associated with signaling one of the input values. In some embodiments, the mobile device causes a representation of the gesture to be displayed to the user.

At 520, in the illustrated embodiment, the mobile device displays, based on the configuration information, a private interface that is visible to a user of the computing device and not to other users, where the private interface indicates the relationship of the input values to the input actions. In some embodiments, the input actions include user selection of one or more locations, where the one or more input values appear to the user, in the private interface, to be located at corresponding ones of the one or more locations.

In some embodiments, the selectable locations are within an area in which the other device is configured to sense gestures from the user. In some embodiments, the display of the private interface is based on coordinates of an area included in the configuration information. In some embodiments, the mobile device processes one or more images to determine where to display the ones of the input values, where the one or more images capture the locations selectable by a user. In some embodiments, the mobile device is a wearable device and the display of the private interface is performed using one or more displays that are located in front of the eyes of the user when the wearable device is worn.

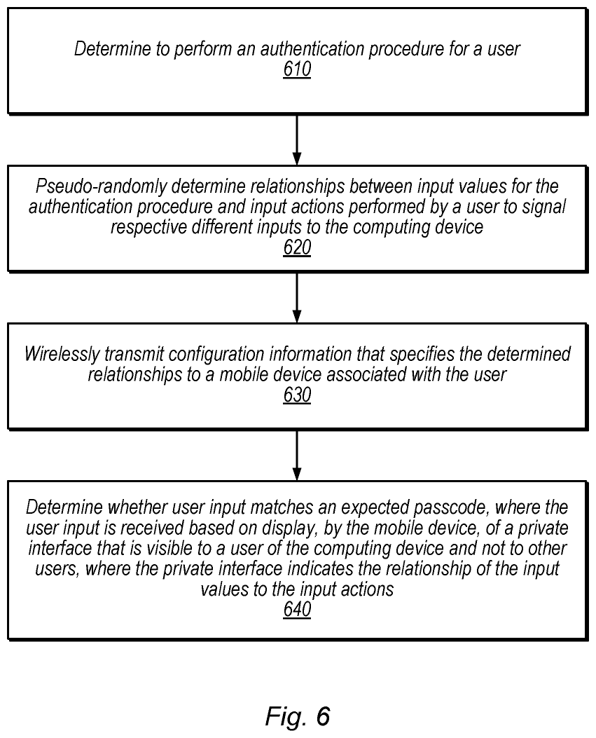

FIG. 6 is a flow diagram illustrating an exemplary method for performing an authentication procedure based on user input using a pseudo-randomly generated input value configuration, according to some embodiments. The method shown in FIG. 6 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired.

At 610, in the illustrated embodiment, the authentication device determines to perform an authentication procedure for a user. This determination may be in response to user input, a user action such as inserting a debit card, wireless communications with a device of the user, etc.

At 620, in the illustrated embodiment, the authentication device pseudo-randomly determines relationships between input values for the authentication procedure and input actions performed by a user to signal respective different inputs to the authentication device.

At 630, in the illustrated embodiment, the authentication device wirelessly transmits configuration information that specifies the determined relationships to a mobile device associated with the user. In some embodiments, the authentication device determines to wirelessly transmit the configuration information to the mobile device based on a signal strength of the mobile device. In some embodiments, the authentication device determines to wirelessly transmit the configuration information to the mobile device in response to identifying the mobile device based on prior registration of the mobile device with a system associated with the computing device.

At 640, in the illustrated embodiment, the authentication device determines whether user input matches an expected passcode, where the user input is received based on display, by the mobile device, of a private interface that is visible to a user of the authentication device and not to other users, where the private interface indicates the relationship of the input values to the input actions. In some embodiments, the input actions include user selection of one or more locations at which the one or more input values appear to the user, in the private interface, to be located at corresponding ones of the one or more locations. In some embodiments, the locations correspond to a plurality of regions of a display device that accepts user input. In some embodiments, the authentication device displays images for ones of the plurality of regions that are different than input values related to those ones of the plurality of regions.

In some embodiments, based on determining whether received user input matches an expected passcode, the authentication device generates an authentication result for the user.

In various embodiments, the disclosed techniques for displaying a private interface to the user (e.g., containing a pseudo-random display of input values) may advantageously reduce or avoid situations where other individuals or entities determine information entered by the user.

### Example Computing Device

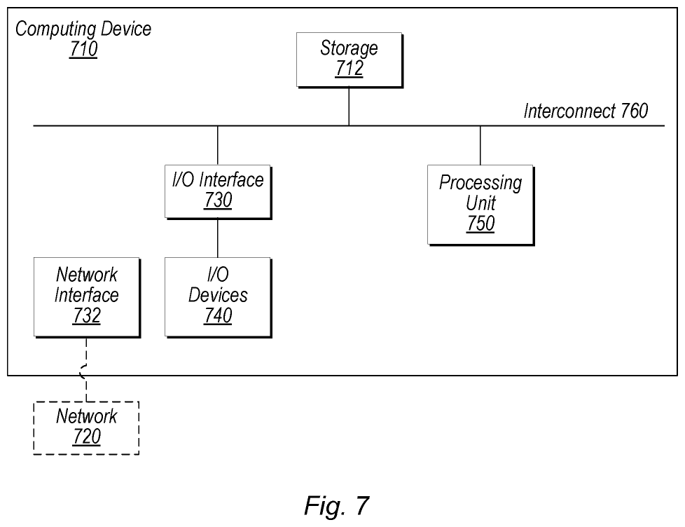

Turning now to FIG. 7, a block diagram of one embodiment of computing device (which may also be referred to as a computing system) 710 is depicted. Computing device 710 may be used to implement various portions of this disclosure. Computing device 710 may be any suitable type of device, including, but not limited to, a personal computer system, desktop computer, laptop or notebook computer, mainframe computer system, web server, workstation, or network computer. As shown, computing device 710 includes processing unit 750, storage 712, and input/output (I/O) interface 730 coupled via an interconnect 760 (e.g., a system bus). I/O interface 730 may be coupled to one or more I/O devices 740. Computing device 710 further includes network interface 732, which may be coupled to network 720 for communications with, for example, other computing devices.

In various embodiments, processing unit 750 includes one or more processors. In some embodiments, processing unit 750 includes one or more coprocessor units. In some embodiments, multiple instances of processing unit 750 may be coupled to interconnect 760. Processing unit 750 (or each processor within 750) may contain a cache or other form of on-board memory. In some embodiments, processing unit 750 may be implemented as a general-purpose processing unit, and in other embodiments it may be implemented as a special purpose processing unit (e.g., an ASIC). In general, computing device 710 is not limited to any particular type of processing unit or processor subsystem.

As used herein, the terms “processing unit” or “processing element” refer to circuitry configured to perform operations or to a memory having program instructions stored therein that are executable by one or more processors to perform operations. Accordingly, a processing unit may be implemented as a hardware circuit implemented in a variety of ways. The hardware circuit may include, for example, custom very-large-scale integration (VLSI) circuits or gate arrays, off-the-shelf semiconductors such as logic chips, transistors, or other discrete components. A processing unit may also be implemented in programmable hardware devices such as field programmable gate arrays, programmable array logic, programmable logic devices, or the like. A processing unit may also be configured to execute program instructions from any suitable form of non-transitory computer-readable media to perform specified operations.

Storage subsystem 712 is usable by processing unit 750 (e.g., to store instructions executable by and data used by processing unit 750). Storage subsystem 712 may be implemented by any suitable type of physical memory media, including hard disk storage, floppy disk storage, removable disk storage, flash memory, random access memory (RAM-SRAM, EDO RAM, SDRAM, DDR SDRAM, RDRAM, etc.), ROM (PROM, EEPROM, etc.), and so on. Storage subsystem 712 may consist solely of volatile memory, in one embodiment. Storage subsystem 712 may store program instructions executable by computing device 710 using processing unit 750, including program instructions executable to cause computing device 710 to implement the various techniques disclosed herein.

I/O interface 730 may represent one or more interfaces and may be any of various types of interfaces configured to couple to and communicate with other devices, according to various embodiments. In one embodiment, I/O interface 730 is a bridge chip from a front-side to one or more back-side buses. I/O interface 730 may be coupled to one or more I/O devices 740 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

What is claimed is:

1. A non-transitory computer-readable medium having instructions stored thereon that are executable by a computing device to perform operations comprising:
receiving configuration information for user input of a passcode to another device, wherein the configuration information specifies a pseudo-random relationship of input values to input actions recognized by the other device; and
displaying, based on the configuration information, a private interface that is visible to a user of the computing device and not to other users, wherein the private interface indicates the relationship of the input values to the input actions.

2. The non-transitory computer-readable medium of claim 1, wherein the input actions include user selection of one or more locations and wherein one or more input values appear to the user, in the private interface, to be located at corresponding ones of the one or more locations.

3. The non-transitory computer-readable medium of claim 2, wherein the selectable locations are within a region in which the other device is configured to sense gestures from the user and wherein the displaying is based on coordinates of the region included in the configuration information.

4. The non-transitory computer-readable medium of claim 2, wherein the operations further comprise:
processing one or more images to determine where to display the ones of the input values, wherein the one or more images capture the locations selectable by a user.

5. The non-transitory computer-readable medium of claim 1, wherein the configuration information includes different sets of pseudo-random relationships of the input values to input actions for input of different portions, by the user, of the passcode.

6. The non-transitory computer-readable medium of claim 1, wherein the operations further comprise:
determining a gesture of the user associated with signaling one of the input values; and
causing a representation of the gesture to be displayed to the user.

7. The non-transitory computer-readable medium of claim 1, wherein the computing device is a wearable device and wherein the displaying the private interface is performed using one or more displays that are located in front of the eyes of the user when the wearable device is worn.

8. An apparatus, comprising:
one or more processing elements configured to:
receive configuration information for user input of a passcode to another device, wherein the configuration information specifies a pseudo-random relationship of input values to input actions recognized by the other device; and
display, based on the configuration information, a private interface that is visible to a user of the apparatus and not to other users, wherein the private interface indicates the relationship of the input values to the input actions.

9. The apparatus of claim 8, wherein the input actions include user selection of one or more locations and wherein one or more input values appear to the user, in the private interface, to be located at corresponding ones of the one or more locations.

10. The apparatus of claim 9, wherein the apparatus is configured to:
process one or more images that capture the locations selectable by a user to determine where to display the ones of the input values.

11. The apparatus of claim 8, wherein the configuration information includes different sets of pseudo-random relationships of the input values to input actions for input of different portions, by the user, of the passcode.

12. The apparatus of claim 8, wherein the apparatus is further configured to:
determine a gesture of the user associated with signaling one of the input values; and
cause a representation of the gesture to be displayed to the user.

13. The apparatus of claim 8, wherein the apparatus is further configured to:
receive information from the other device indicating a region in which to overlay input values for gestures from the user.

14. A non-transitory computer-readable medium having instructions stored thereon that are executable by a computing device to perform operations comprising:
determining to perform an authentication procedure for a user;
pseudo-randomly determining relationships between input values for the authentication procedure and input actions performed by a user to signal respective different inputs to the computing device;
wirelessly transmitting configuration information that specifies the determined relationships to a mobile device associated with the user; and
determining whether user input matches an expected passcode, wherein the user input is received based on display, by the mobile device, of a private interface that is visible to a user of the computing device and not to other users, wherein the private interface indicates the relationship of the input values to the input actions.

15. The non-transitory computer-readable medium of claim 14, wherein the input actions include user selection of one or more locations and wherein one or more input values appear to the user, in the private interface, to be located at corresponding ones of the one or more locations.

16. The non-transitory computer-readable medium of claim 15, wherein the locations correspond to a plurality of regions of a display device that accepts user input, wherein the operations further comprise:
displaying images for ones of the plurality of regions that are different than the input values related to those ones of the plurality of regions.

17. The non-transitory computer-readable medium of claim 14, wherein the operations further comprise:
determining to wirelessly transmit the configuration information to the mobile device based on a signal strength of the mobile device.

18. The non-transitory computer-readable medium of claim 14, wherein the operations further comprise:
determining to wirelessly transmit the configuration information to the mobile device in response to identifying the mobile device based on prior registration of the mobile device with a system associated with the computing device.

19. The non-transitory computer-readable medium of claim 14, wherein the pseudo-randomly determining relationships is performed multiple times to generate different relationships for input of different input values, by the user, of the passcode.

20. The non-transitory computer-readable medium of claim 14, wherein the operations further comprise:
based on determining whether received user input matches an expected passcode, generating an authentication result for the user.
